(19) United States
(12) Patent Application Publication
(10) Pub. No.: US 2019/0232976 A1
(43) Pub. Date: Aug. 1, 2019

(54) ASSISTING APPARATUS, ASSISTING METHOD, AND PROGRAM

(71) Applicant: OMRON Corporation, Kyoto-shi (JP)

(72) Inventors: Mei UETANI, Uji-shi (JP); Tadashi HYUGA, Hirakata-shi (JP); Hatsumi AOI, Kyotanabe-shi (JP)

(73) Assignee: OMRON Corporation, Kyoto-shi (JP)

(21) Appl. No.: 16/382,635

(22) Filed: Apr. 12, 2019

Related U.S. Application Data
(63) Continuation of application No. PCT/JP2017/033148, filed on Sep. 13, 2017.

(30) Foreign Application Priority Data
Mar. 9, 2017 (JP) 2017-045143

(51) Int. Cl. B60W 50/14; B60W 50/08; G05D 1/00; B60W 40/072; G08G 1/0967

(52) U.S. Cl. CPC B60W 50/14; B60W 50/082; G05D 1/0061; B60W 40/072; B60W 2050/146; G05D 1/0088; G05D 2201/0213; B60W 2550/402; G08G 1/096708

(57) ABSTRACT

An assisting apparatus assists in mode switching for switching a drive mode of a vehicle between a manual drive mode and an automatic drive mode. The assisting apparatus includes an obtaining unit and a calculation unit. The obtaining unit obtains surrounding data representing a surrounding situation of the vehicle. The calculation unit calculates a recommended mode switching position at which the mode switching is recommended based on the obtained surrounding data.

### CROSS REFERENCE TO RELATED APPLICATIONS

This application is a continuation application of International Application No. PCT/JP2017/033148, filed on Sep. 13, 2017, which claims priority based on the Article 8 of Patent Cooperation Treaty from prior Japanese Patent Application No. 2017-045143, filed on Mar. 9, 2017, the entire contents of which are incorporated herein by reference.

### FIELD

The disclosure relates to a technique for switching the drive mode of a vehicle between a manual drive mode and an automatic drive mode.

### BACKGROUND

As techniques for automating vehicle driving have been receiving attention, the automatic drive mode is now under consideration for use. In the automatic drive mode, a computer mainly operates a vehicle, unlike in a manual drive mode in which a driver, relying on his or her perception, operates a vehicle with hands and feet.

The automatic drive mode enables automatic driving of a vehicle by controlling, for example, a power unit, a steering unit, and a brake based on various items of information obtained with various sensors or through communications. Such information includes position measurement information obtained from a global positioning system (GPS), map information from a car navigation system, traffic information obtained through road-to-vehicle communication, monitoring information from a surrounding monitoring system that monitors the positions and movements of nearby pedestrians and vehicles, and posture information of a vehicle obtained from a three-axis sensor.

The automatic drive mode is expected to reduce the burden of drivers or ease traffic congestion. However, a driver may have some situations to hold the steering wheel and drive the vehicle on a route from a starting point to a destination. For example, the driver may use the automatic drive mode on expressways, but may use the manual drive mode on ordinary roads as appropriate. Techniques are to be developed for safely switching between the automatic drive mode and the manual drive mode.

For example, Japanese Unexamined Patent Application Publication No. 2015-141560 describes a technique for changing the timing to stop automatic driving. Japanese Unexamined Patent Application Publication No. 2015-141560 describes resetting the timing to stop automatic driving as requested by the driver when any event that can stop automatic driving is found on the route ahead. However, no technique is described therein for determining an appropriate time point for switching and recommending the time point to the driver in response to the driver's request to switch from the automatic drive mode to the manual drive mode.

Various techniques have been developed for switching between the automatic drive mode and the manual drive mode. In one example, a preparatory time period for switching (e.g., 60 sec) is defined, during which preparations including looking around to ensure safety are performed before the drive mode switching. In another example, a switching section with a predetermined distance (e.g., about 100 meters to several kilometers) may be defined on a route before an interchange to allow the driver to have a sufficient time to switch the drive mode.

For example, the switching section may include positions (or places) appropriate or inappropriate for the drive mode switching depending on the surrounding situation, such as the road geometries or traffic congestion. Also, the appropriate switch positions can change over time as the surrounding situation changes. Effectively recommending an appropriate position for mode switching to a driver can enhance the driver's safety in the drive mode switching.

One or more aspects are directed to an assisting apparatus, an assisting method, and a program that enable drive mode switching at an appropriate position to improve safety.

### SUMMARY

An assisting apparatus according to a first aspect assists in switching a drive mode of a vehicle between a manual drive mode and an automatic drive mode. The apparatus includes an obtaining unit that obtains surrounding data representing a surrounding situation of the vehicle, and a calculation unit that calculates a recommended mode switching position at which mode switching is recommended based on the obtained surrounding data.

An assisting apparatus according to a second aspect is the apparatus according to a first aspect in which the obtaining unit obtains map data about surroundings of the vehicle from a database storing digital map data, and the calculation unit calculates the recommended mode switching position based on the obtained map data.

An assisting apparatus according to a third aspect is the apparatus according to a second aspect in which the calculation unit calculates a curvature of a road in a traveling direction of the vehicle based on the map data, and calculates the recommended mode switching position using the curvature as a criterion.

An assisting apparatus according to a fourth aspect is the apparatus according to a first aspect further including a reception unit that receives public traffic information. The calculation unit calculates the recommended mode switching position based on the received public traffic information.

An assisting apparatus according to a fifth aspect is the apparatus according to a fourth aspect in which the calculation unit calculates the recommended mode switching position using a congestion situation in a traveling direction of the vehicle obtained from the public traffic information as a criterion.

An assisting apparatus according to a sixth aspect is the apparatus according to any one of first to fifth aspects further including a notification unit that notifies the recommended mode switching position to a driver.

An assisting apparatus according to a seventh aspect is the apparatus according to a sixth aspect in which the notification unit displays the recommended mode switching position superimposed on a map image of surroundings of the vehicle on a display.

An assisting apparatus according to an eighth aspect is the apparatus according to a sixth aspect in which the notification unit notifies, with a voice, a time length to reach the recommended mode switching position to the driver of the vehicle.

An assisting apparatus according to a ninth aspect is the apparatus according to a sixth aspect further including a section defining unit that defines a switching section for the mode switching including the recommended mode switching position on a road traveled by the vehicle. The notification unit notifies the defined switching section to the driver.

An assisting apparatus according to a tenth aspect is the apparatus according to a ninth aspect in which the calculation unit calculates a distribution of numerical indexes each indicating a degree of recommendation about the mode switching in the switching section, and the notification unit associates the indexes with display colors on the map image of the surroundings of the vehicle to display the indexes in a color map.

An assisting apparatus according to an eleventh aspect is the apparatus according to a ninth aspect in which the section defining unit defines the switching section in response to an intention of an operator to switch the drive mode.

The assisting apparatus according to a first aspect obtains surrounding data representing a surrounding situation of the vehicle. The assisting apparatus then calculates a recommended mode switching position at which the mode switching is recommended based on the surrounding data.

This structure calculates a position particularly recommended for mode switching as the recommended mode switching position, which may be stored into, for example, a memory in an in-vehicle computer. Based on the above information, for example, the automatic driving controller in the vehicle may automatically perform various control operations for switching the drive mode using the recommended mode switching position as a target point. This enables the driver to switch the drive mode at a recommended position to improve safety in mode switching.

The assisting apparatus according to a second aspect obtains map data about surroundings of the vehicle, which is an example of surrounding data, from a database storing digital map data (e.g., an in-vehicle navigation system or a website providing map information). Based on the map data, the assisting apparatus calculates the recommended mode switching position at which the mode switching is recommended.

This structure enables drive mode switching at the recommended mode switching position calculated based on the map data.

The assisting apparatus according to a third aspect calculates a curvature of a road in a traveling direction of the vehicle based on the map data, and the recommended mode switching position using the curvature as a criterion. Thus, for example, a position in a gentle curve is determined as the recommended mode switching position, whereas a position in a smaller curvature radius (a sharp curve) is not recommended. This improves safety in mode switching.

The assisting apparatus according to a fourth aspect receives public traffic information under frequency modulation (FM) using, for example, a radio, and calculates the recommended mode switching position based on the public traffic information, which is an example of surrounding data. For example, as in a fifth aspect, the recommended mode switching position is calculated using a congestion situation in a traveling direction according to the public traffic information as a criterion. This structure can determine the recommended mode switching position to avoid traffic congestion or accidents in a traveling direction, thus improving safety in mode switching.

The assisting apparatus according to a sixth aspect notifies, with the notification unit, the recommended mode switching position to the vehicle driver. This structure allows the driver to have a sufficient time to take over the control (such as looking around or taking over the operation of depressing the accelerator) before reaching the recommended mode switching position. The structure also allows the drive mode switching at a position with fewer obstacles. The mode switching can thus be effectively recommended at an appropriate position, thus effectively supporting the driver's safety and greatly improving safety in mode switching.

The assisting apparatus according to a seventh aspect displays the recommended mode switching position superimposed on the map image of the surroundings of the vehicle appearing on a display (e.g., a touchscreen of a car navigation system, a head-up display, and a display of a smartphone or a tablet). The driver can thus visually recognize the recommended mode switching position, thus having greatly improved safety in mode switching.

The assisting apparatus according to an eighth aspect notifies, with the notification unit, with a voice, a time length to reach the recommended mode switching position to the driver. For example, the driver may be notified of the time period from the current time to the estimated time of passing through the recommended mode switching position by counting down the time. The driver can thus audibly recognize the recommended mode switching position and thus visually concentrate on monitoring the surroundings. This greatly improves safety in mode switching.

The assisting apparatus according to a ninth aspect defines, with the section defining unit, a switching section for mode switching including the recommended mode switching position on a road traveled by the vehicle, and notifies, with the notification unit, the defined switching section to the driver. For example, according to an eleventh aspect, the switching section is defined in response to an operator's intention to switch the drive mode. This structure defines the switching section not mechanically but intelligently based on calculation results for safer positions. This greatly improves safety in mode switching.

The assisting apparatus according to a tenth aspect calculates, with the calculation unit, the distribution of numerical indexes each indicating the degree of recommendation about the mode switching in the switching section. The notification unit associates the indexes with display colors on the map image to display the indexes in a color map. The numerical indexes each indicating the degree of recommendation about the mode switching are, for example, the inverse numbers of curvature radiuses of the road. More specifically, the index values are greater at positions with greater curvature radiuses. The indexes may also be calculated based on various parameters such as presence of obstacles on a road, distances to the obstacles, and points of accidents (each of which can be obtained through public traffic information).

For example, the switching section may be displayed on a display by using a bar or strip icon. The depth of a display color (or hues of display colors) in the bar may be associated with the indexes. The driver can thus readily recognize the positions appropriate and inappropriate for mode switching. This greatly improves safety in mode switching.

### BRIEF DESCRIPTION OF THE DRAWINGS

FIG. 1 is a block diagram illustrating an automatic driving control system including a mode switch assisting apparatus according to one or more embodiments.

FIG. 2 is a functional block diagram illustrating a mode switch assisting apparatus, such as in FIG. 1.

FIG. 3 is a flow diagram illustrating an example procedure performed by a mode switch assisting apparatus, such as in FIG. 2.

FIGS. 4A and 4B are diagrams illustrating example navigation screens appearing on a display.

FIGS. 5A and 5B are diagrams illustrating example navigation screens appearing on a display.

FIGS. 6A and 6B are diagrams illustrating example navigation screens appearing on a display.

FIG. 7 is a diagram illustrating an example voice message output from a speaker.

FIG. 8 is a diagram illustrating another example voice message output from a speaker.

FIG. 9 is a diagram illustrating a strip icon indicating a switching section.

### DETAILED DESCRIPTION

### Embodiments

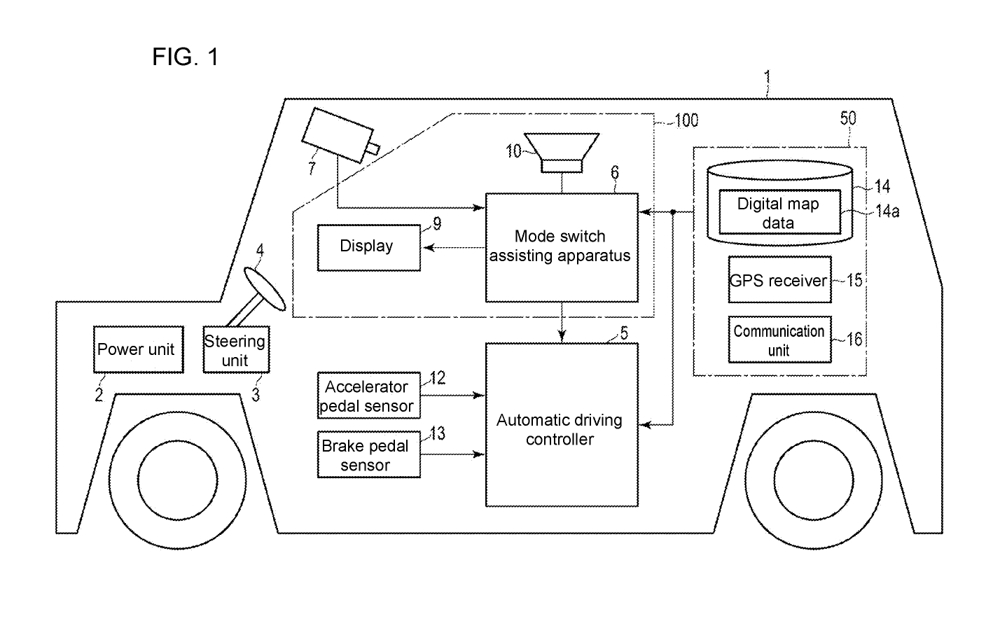

One or more embodiments will now be described with reference to the drawings. FIG. 1 is a block diagram of an automatic driving control system including a mode switch assisting apparatus according to one or more embodiments. The automatic driving control system is mounted on a vehicle 1. The vehicle 1 can travel either in a manual drive mode or an automatic drive mode. The vehicle 1 includes, as its basic components, a power unit 2 and a steering unit 3. The power unit 2 includes a power supply and a transmission. The power supply includes an internal combustion engine, an electric motor, or both. The steering unit 3 is connected to a steering wheel 4.

The manual drive mode allows the vehicle 1 to travel mainly based on, for example, a manual driving operation performed by a driver. For example, the manual drive mode may include a vehicle driving operation mode for driving a vehicle with a driving operation performed by the driver alone, and an assisted drive mode for driving a vehicle mainly with a driving operation performed by a driver in combination with assisted driving.

For example, when the vehicle 1 travels along a curve, assisted driving assists the driver with steering the vehicle 1 to allow traveling along the curve. Assisted driving may further include control for assisting in the driver's acceleration (e.g., accelerator pedal operation) or the braking (e.g., brake pedal operation), manual steering (manual steering during driving), and manual speed regulation (manual speed control during driving). Manual steering refers to steering the vehicle 1 mainly with the driver's operation on the steering wheel 4. Manual speed regulation refers to adjusting the speed of the vehicle mainly with the driver's accelerating operation or braking operation.

In contrast, the automatic drive mode enables, for example, automatic driving of a vehicle along a road on which the vehicle is traveling. The automatic drive mode may include automatic driving of a vehicle to a predetermined destination without the driver performing a driving operation. The automatic drive mode is not limited to complete automatic control of the vehicle. For example, the automatic drive mode may include driving that reflects the driver's operation in the traveling vehicle within a predetermined allowable range.

The automatic driving controller 5 shown in FIG. 1 controls driving in the automatic drive mode. The automatic driving controller 5 obtains sensing data from an accelerator pedal sensor 12 and a brake pedal sensor 13. The automatic driving controller 5 controls the traveling of the vehicle 1 based on the sensing data, digital map data 14a stored in a storage 14 of a navigation system 50, route information, traffic information obtained through road-to-vehicle communication, and information obtained by a surrounding monitoring system that monitors the positions and movements of nearby pedestrians and vehicles.

The navigation system 50 according to one or more embodiments includes the storage 14, a global positioning system (GPS) receiver 15, and a communication unit 16. The GPS receiver 15 captures signals from multiple GPS satellites, and calculates three-dimensional positional information (position measurement information) for the vehicle 1 based on position measurement information transmitted from each satellite.

The communication unit 16 can perform wireless communication, and obtains public traffic information from an information providing system such as the Vehicle Information and Communication System (VICS) (registered trademark). Public traffic information may include information about traffic congestion on roads around the vehicle 1 or information about sites where traffic accidents have occurred. The communication unit 16 may perform, in addition to road-to-vehicle communication, inter-vehicle communication with other vehicles to obtain information about roads, facilities, and buildings near the vehicle 1. The communication unit 16 may be implemented using a communication device installed in the vehicle 1 or a general-purpose mobile terminal, such as a smartphone.

The automatic control includes, for example, autosteering (automatic steering during driving) and automatic speed regulation (automatic speed regulation during driving). Autosteering enables a driving state in which the steering unit 3 is controlled automatically. Autosteering includes lane keeping assist (LKA). LKA automatically controls the steering unit 3 to prevent the vehicle 1 from leaving the driving lane when, for example, the driver is not performing a steering operation. During the operation of LKA, the steering operation of the driver may be reflected in the vehicle steering within the range in which the vehicle 1 stays in the driving lane (allowable range). Autosteering is not limited to LKA.

Automatic speed regulation enables a driving state in which the speed of the vehicle 1 is controlled automatically. Automatic speed regulation includes adaptive cruise control (ACC). For example, ACC controls the vehicle 1 to travel at a predefined constant speed while no preceding vehicle is traveling ahead of the vehicle 1. With a preceding vehicle traveling ahead of the vehicle 1, ACC performs tracking control to regulate the speed of the vehicle 1 in accordance with the distance from the preceding vehicle.

During the operation of ACC, the automatic driving controller 5 decelerates the vehicle 1 in response to the driver's braking (e.g., brake pedal operation). During the operation of ACC, the automatic driving controller 5 may accelerate the vehicle in response to the driver's acceleration (e.g., accelerator pedal operation) up to a predetermined maximum permissible speed (e.g., the legally defined maximum speed on the road being traveled). Automatic speed regulation is not limited to ACC, but may include cruise control (CC, which performs constant speed control).

The automatic driving control system according to one or more embodiments includes a mode switch assisting system 100. The mode switch assisting system 100 assists in switching the drive mode of a vehicle. The mode switch assisting system 100 includes a mode switch assisting apparatus 6, which is a computer for assisting mode switching. Switching from the automatic drive mode to the manual drive mode will be described below.

The mode switch assisting system 100 includes a display 9 and a speaker 10. The display 9, which is an example of a display, is a human-machine interface between an occupant of a vehicle including a driver and the mode switch assisting apparatus 6. The display 9 displays a map around the vehicle and various items of information and messages. The speaker 10 also serves as a human-machine interface, and outputs voice messages.

The mode switch assisting system 100 may be connected to a driver camera 7. The driver camera 7 is installed at a position to capture images of the driver, such as on the dashboard, and captures images of the vehicle interior including the driver. The generated video signal is output to the mode switch assisting apparatus 6.

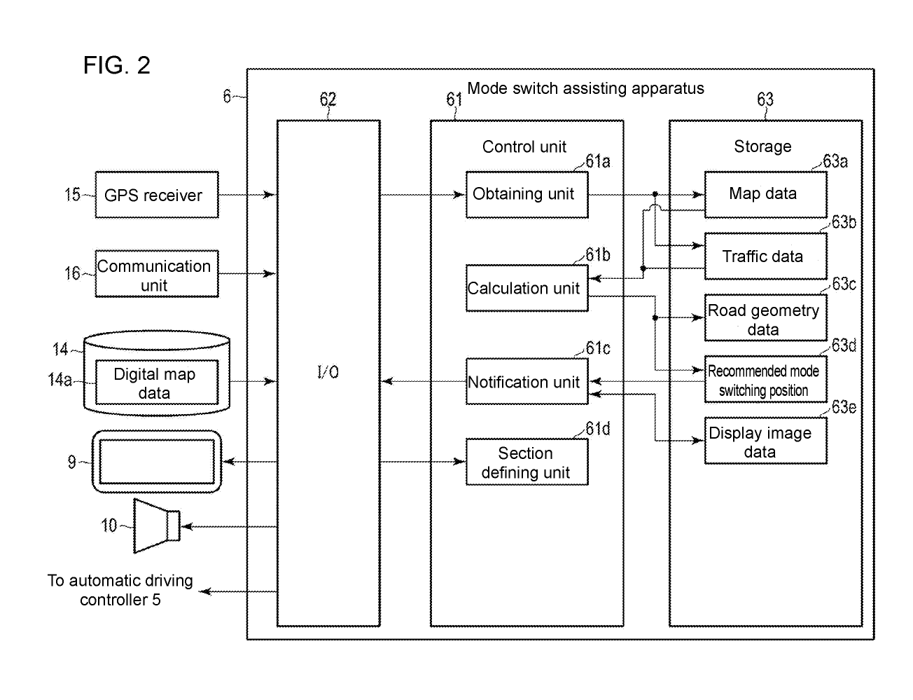

FIG. 2 is a functional block diagram of the mode switch assisting apparatus 6. The mode switch assisting apparatus 6 includes a control unit 61, an input-output interface (I/O) 62, and a storage 63.

The I/O 62 obtains digital map data 14a at an address designated by the control unit 61 from the storage 14, and stores the data into the storage 63 (map data 63a). The I/O 62 also provides display image data to the display 9 to display an intended image, and transfers sound signal data to the speaker 10 and outputs the sound signal data audibly.

The control unit 61 includes a central processing unit (CPU) included in a computer, and a memory. The control unit 61 includes, as its functions for implementing one or more embodiments, an obtaining unit 61a, a calculation unit 61b, a notification unit 61c, and a section defining unit 61d. These functions are implemented by the CPU executing programs stored in the memory.

More specifically, the obtaining unit 61a is implemented by the computer executing an instruction for obtaining the digital map data 14a from the storage 14. The calculation unit 61b is implemented by the computer executing an instruction for calculating, based on the map data, a recommended mode switching position, at which the mode switching is recommended. The notification unit 61c is implemented by the computer executing an instruction for notifying the recommended mode switching position to the driver of the vehicle 1.

The section defining unit 61d is implemented by the computer executing an instruction for defining a switching section for mode switching including the recommended mode switching position on a road traveled by the vehicle 1.

A switching section may be predefined before an exit of an interchange on an expressway. As described above, a switching section may be fixed in some situations including the design of a road.

In one or more embodiments, a switching section may be defined at a substantially freely selected position. In one or more embodiments, a switching section is defined with a range of 100 meters to several kilometers ahead of the vehicle 1 by the section defining unit 61d in response to a driver's intention to switch from the automatic drive mode to the manual drive mode. However, some positions may be appropriate for the drive mode switching section, but others are not. A technique for searching for a safer position, and recommending the position to the driver will be described in one or more embodiments.

The driver's intention to switch the drive mode may be provided by, for example, operating a push button on the steering wheel 4 or a software button on a touch screen, or by operating an accelerator pedal. The driver's intention may be provided with his or her voice recognized by the computer.

The obtaining unit 61a obtains, for example, map data with a range of 100 meters to several kilometers ahead of the vehicle 1 from the storage 14, and stores the data into the storage 63 (map data 63a). The obtaining unit 61a obtains public traffic information (hereafter, traffic data), which is received and decoded by the communication unit 16, from the communication unit 16, and stores the information into the storage 63 (traffic data 63b). The map data 63a or the traffic data 63b is an example of surrounding data representing the situation surrounding the vehicle 1.

The calculation unit 61b calculates a recommended mode switching position, which is a recommended position for mode switching, based on the obtained map data 63a. More specifically, the calculation unit 61b processes the map data 63a, and calculates a curvature radius as an index of the road geometries in the traveling direction of the vehicle 1. Through the above processing, road geometry data 63c is generated. The road geometry data 63c is then stored into the storage 63. The calculation unit 61b determines a position with the largest curvature radius as a recommended mode switching position using a curvature radius indicated by the road geometry data 63c as a criterion.

The recommended mode switching position in one or more embodiments is a position at which the mode can be switched in the safest manner. For example, mode switching is safe on a straight road. Mode switching is also safe in sections without traffic congestion or at places away from vehicles involved in an accident or fallen objects.

The recommended mode switching position may be expressed with numerical values, such as a latitude and a longitude or coordinates in the XY-coordinate system. The recommended mode switching position expressed with numerical values is stored into the storage 63 as recommended mode switching position data 63d.

A safe position is not limited to the recommended mode switching position, and may range across areas within the switching section. The calculation unit 61b thus calculates the distribution of numerical indexes each indicating the degree of recommendation about the mode switching (hereafter, recommendation degree) as, for example, the inverse of the road curvature radius.

The notification unit 61c performs control for notifying the calculated recommended mode switching position to the driver of the vehicle 1. For example, the notification unit 61c visually notifies the recommended mode switching position to the driver by generating image data including the recommended mode switching position superimposed on the map image around the vehicle 1 and displaying the image data on the display 9. The map image around the vehicle 1 may be obtained by reading, from the digital map data 14a, map data corresponding to the positional information for the vehicle 1 output from the GPS receiver 15. The notification unit 61c generates display image data 63e by superimposing an icon indicating the recommended mode switching position on the map data at the coordinates corresponding to the recommended mode switching position. The display image data 63e is stored into the storage 63.

The distribution of recommendation degrees calculated by the calculation unit 61b may also be displayed visually. More specifically, the notification unit 61c generates a color map (heat map) image, which includes the recommendation degrees mapped with display colors, and stores the display image data 63e into the storage 63. The notification unit 61c reads the display image data 63e from the storage 63 and displays the data on the display 9.

The storage 63 stores the map data 63a, the traffic data 63b, the road geometry data 63c, the recommended mode switching position data 63d, and the display image data 63e.

The storage 63 is, for example, a semiconductor memory, such as a random access memory (RAM), a read only memory (ROM), a flash memory, and a synchronous dynamic RAM (SDRAM), or a non-volatile memory, such as an erasable programmable ROM (EPROM) and an electrically erasable programmable ROM (EEPROM). The storage 63 may also be a storage medium, such as a solid state drive (SSD) and a hard disk drive (HDD). In one or more embodiments, the storage 63 may be a storage area included in a one-chip microcomputer, such as a field programmable gate array (FPGA) or a peripheral interface controller (PIC). The advantageous effects of one or more embodiments will now be described based on the above structure.

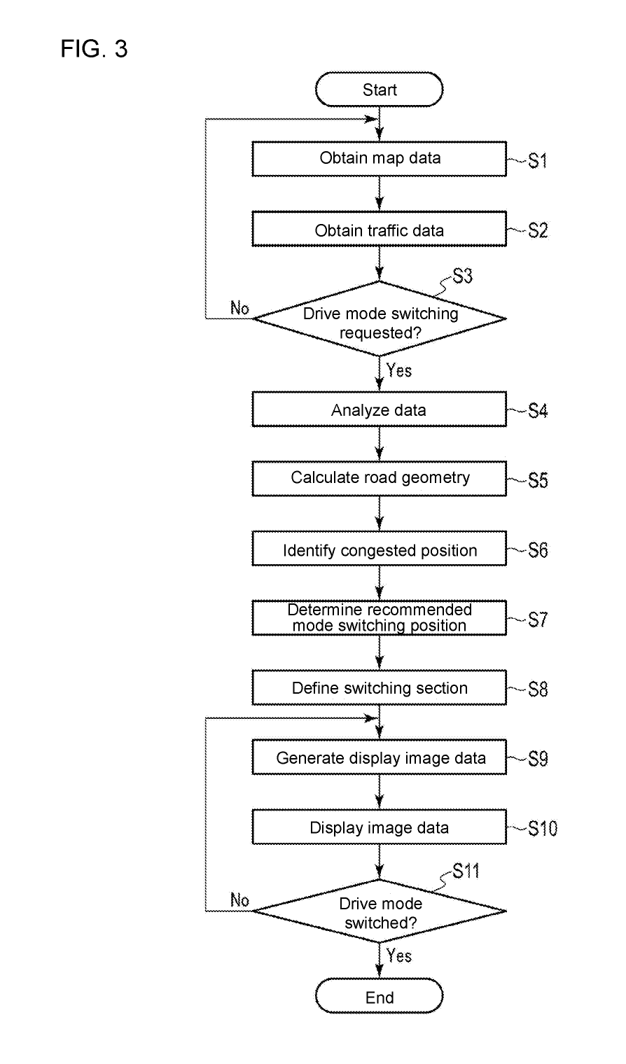

FIG. 3 is a flowchart showing an example procedure performed by the mode switch assisting apparatus 6 shown in FIG. 2. In one or more embodiments, the drive mode is switched to the manual drive mode intentionally by the driver while the vehicle 1 is traveling on an expressway in the automatic drive mode.

While the vehicle 1 is cruising, as shown in FIG. 3, obtaining map data representing the surroundings of the vehicle 1 at the current position of the vehicle 1 measured by the GPS from the storage 14 (step S1), and obtaining traffic data (step S2) are performed continuously. In response to an intention to switch the drive mode (Yes in step S3), the mode switch assisting apparatus 6 analyzes the obtained map data 63a and traffic data 63b (step S4).

Once starting the data analysis, the mode switch assisting apparatus 6 processes the map data 63a with a known pattern recognition technique or a known image data analysis technique, and calculates a curvature radius of a road ahead of the traveling vehicle 1 (step S5). The generated road geometry data 63c is then stored into the storage 63. The mode switch assisting apparatus 6 identifies a congested position in a nearby road by interpreting the traffic data 63b (step S6).

Subsequently, the mode switch assisting apparatus 6 stores a curvature radius at each position on the road in the traveling direction of the vehicle 1 (or for each pixel on the display 9) in, for example, a double array and sorts the information in the order of size based on the road geometry data 63c, and determines a position with the largest curvature radius to be a recommended mode switching position (step S7).

When the position determined to have the largest curvature radius and the congested position identified in step S6 are near each other (e.g., the positions are several tens to several hundred meters away from each other), the mode switch assisting apparatus 6 determines the position with the second largest curvature radius to be the recommended mode switching position. When the recommended mode switching position is determined, the mode switch assisting apparatus 6 defines a section with a predetermined distance (e.g., 1 km) including the recommended mode switching position as a switching section for mode switching (step S8). The mode switch assisting apparatus 6 may define multiple switching sections, instead of defining a single switching section. For example, the mode switch assisting apparatus 6 may define a switching section A including a point with the largest curvature radius and a switching section B including a point with the second largest curvature radius.

The mode switch assisting apparatus 6 then generates, for example, a strip icon in a distinct color corresponding to the defined switching section, and generates the display image data 63e by combining the icon with the latest digital map data 14a read from the storage 14 (step S9). The generated display image data 63e then promptly appears on the display 9 (step S10).

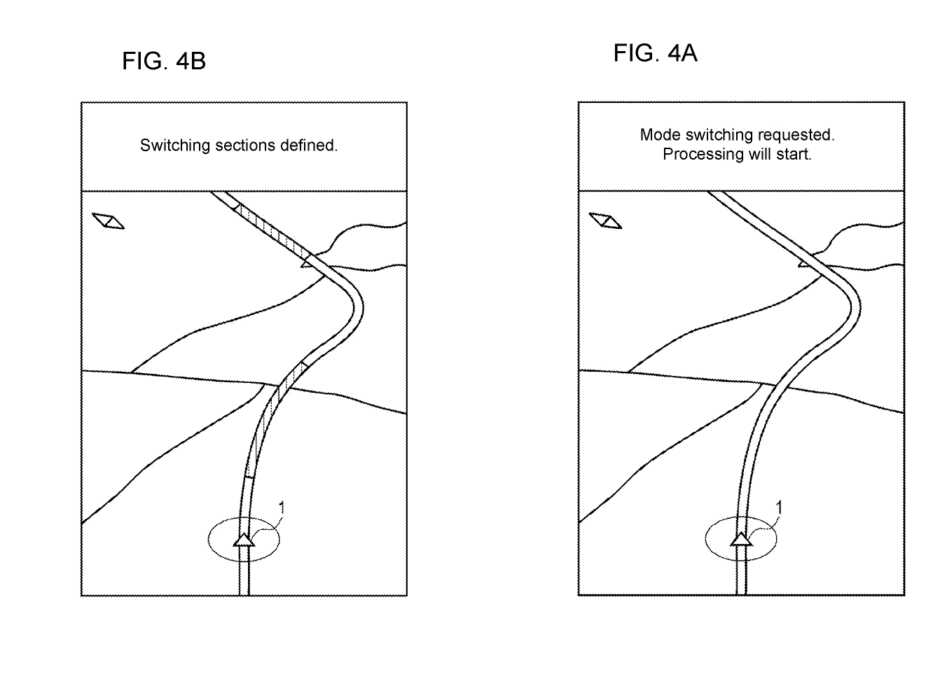

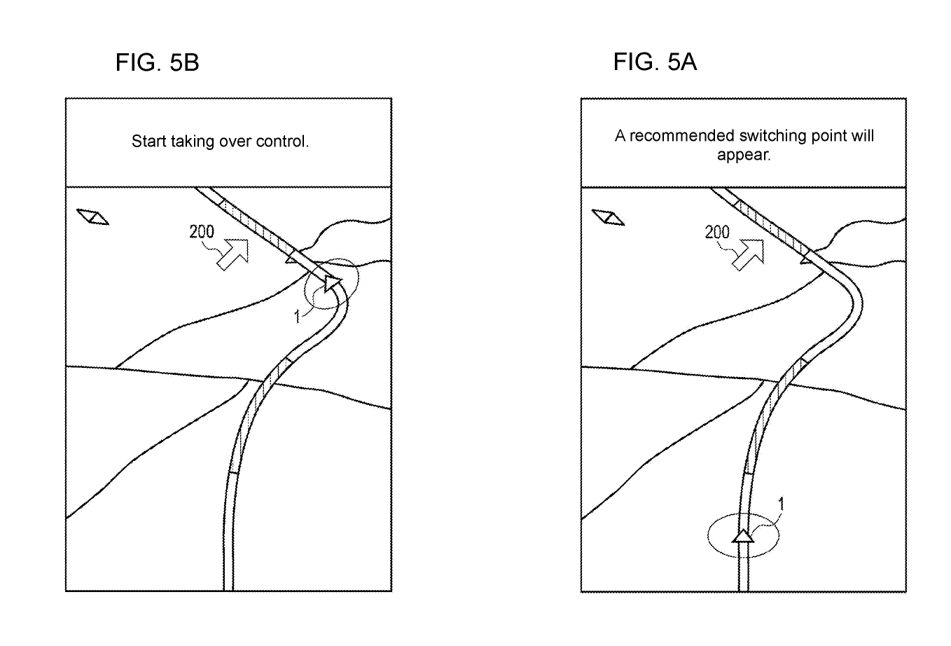

FIGS. 4A to 5B are diagrams describing example navigation screens appearing on the display 9. When an intention for mode switching is detected in step S3 in FIG. 3, a message reading “Mode switching requested. Processing will start.” appears as shown in FIG. 4A on the navigation screen with its normal display. The navigation screen shows, for example, a triangle icon pointing forward, which indicates the vehicle 1, and a road being traveled on by the vehicle 1. Once the processing up to step S8 is completed in FIG. 3, a message reading “Switching sections defined.” and strip icons indicating the switching sections on the road (hatched areas in the drawing) appear as shown in FIG. 4B. The switching sections A and B described in the second preceding paragraph are shown in the drawing.

Subsequently, as shown in FIG. 5A, a message reading “A recommended switch point will appear.” and an arrow symbol icon 200 indicating a recommended mode switching position appears. In FIG. 5A, the arrow pointing toward the switching section farther from the vehicle 1 indicates that the pointed switching section is safer. When the vehicle 1 approaches the section defined for taking over the drive, a message reading “Start taking over control.” appears as shown in FIG. 5B. The driver recognizing the message starts the procedure including looking around or taking over the operation of depressing the pedals. These messages described above may be output through the speaker 10 audibly.

Referring back to FIG. 3, the procedure will be described continuously. The processing in steps S9 and S10 in FIG. 3 is repeated in, for example, cycles corresponding to the updating cycles of data appearing on the display 9 (step S11). Obtaining the map data in step S1 or obtaining the traffic data in step S2 may be in parallel with the processing in another step. The processing in each step may be performed in orders other than the order shown in FIG. 3. When the position of traffic congestion is identified in step S6 in FIG. 3, the information is reflected in the data appearing on the navigation screen and in defining the switching sections.

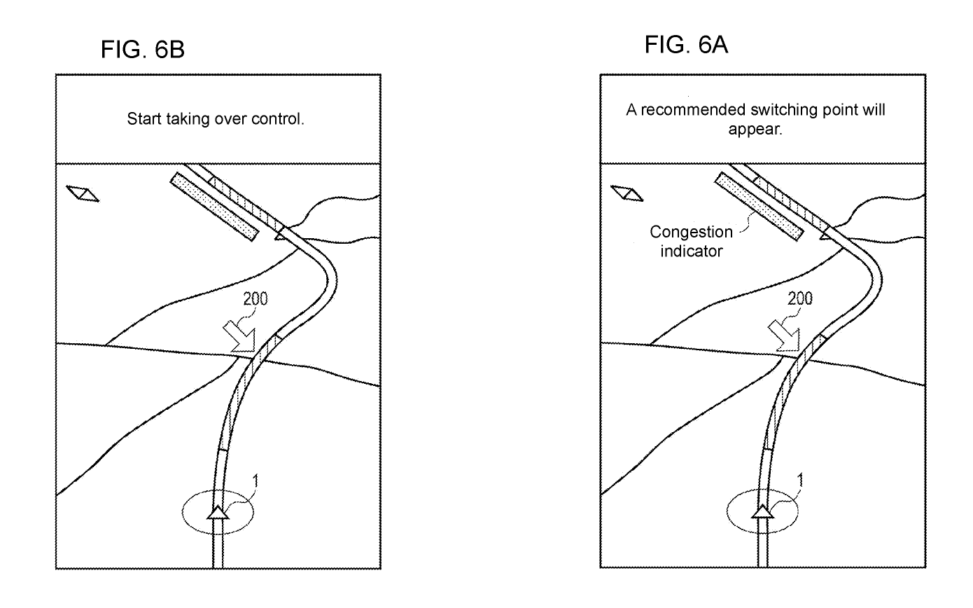

FIGS. 6A and 6B are diagrams describing example navigation screens including congested sections. For example, an indicator indicating the position of traffic congestion (congestion indicator) is shown along the congested section when the congested position is identified. The traffic congestion occurs near the symbol icon 200 shown in FIGS. 5A and 5B. In response to this, the mode switch assisting apparatus 6 defines a recommended mode switching position in the switching section nearer the vehicle 1 to avoid the congested section, and moves the symbol icon 200 to the corresponding position. Thus, the driver viewing the screen can perform mode switching early to avoid the congestion.

During traveling in the automatic drive mode, the calculation unit 61b according to one or more embodiments calculates, in response to the driver's intention to switch to the manual drive mode, the road geometry data 63c indicating the curvature radius at each position along the road before actual mode switching. The calculation is performed using the map data 63a obtained by the obtaining unit 61a. The obtaining unit 61a obtains the traffic data 63b, and provides the data to the calculation unit 61b. The calculation unit 61b interprets the traffic data, and determines whether to detect objects surrounding the vehicle 1 and determines the positions of such objects. The calculation unit 61b then calculates a recommended mode switching position based on the road geometry data 63c and the traffic data 63b. The section defining unit 61d then defines a switching section including the recommended mode switching position. Then, the notification unit 61c generates a navigation image including the switching section, and displays the image with an icon indicating the recommended mode switching position on the display 9.

This structure effectively notifies a switching section including a safer and appropriate switch point to the driver. Thus, the driver can switch the drive mode at a position with fewer obstructions, such as curves or traffic congestion. In other words, this structure may select, for example, a farther and safer area and recommend the area to the driver in response to a request for mode switching from the driver, instead of performing mode switching immediately in a nearby area.

In one or more embodiments, a safe position is determined based on the road geometries calculated using the digital map data 14a or the traffic data obtained from public broadcasting. This structure can collect road condition information in any direction within a range of several kilometers including the vehicle 1, thus allowing the search for a recommended mode switching position in a wider range than when a radar device or an image sensor is used. The technique described in one or more embodiments includes both searching for a safe area in a predefined switching section, and also first searching for a safe area and then defining a switching section near the found area.

The assisting apparatus, the assisting method, and the program according to one or more embodiments enable drive mode switching at an appropriate position to improve safety.

One or more embodiments are not limited to the examples described above. For example, the recommended mode switching position may be notified to the driver through a voice message, instead of appearing on the display 9.

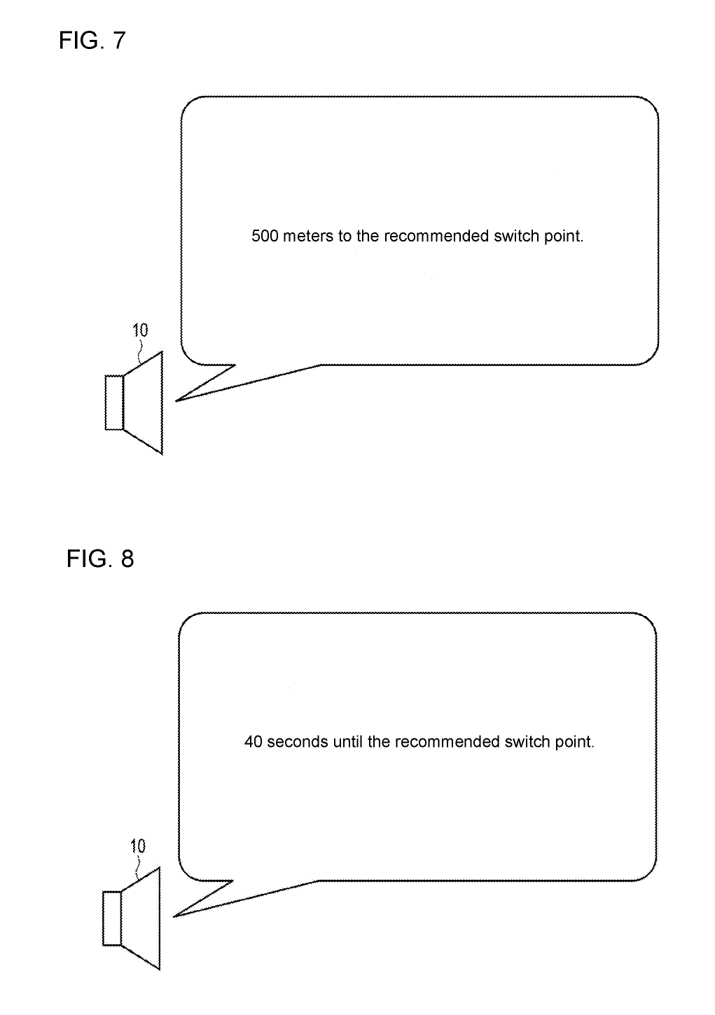

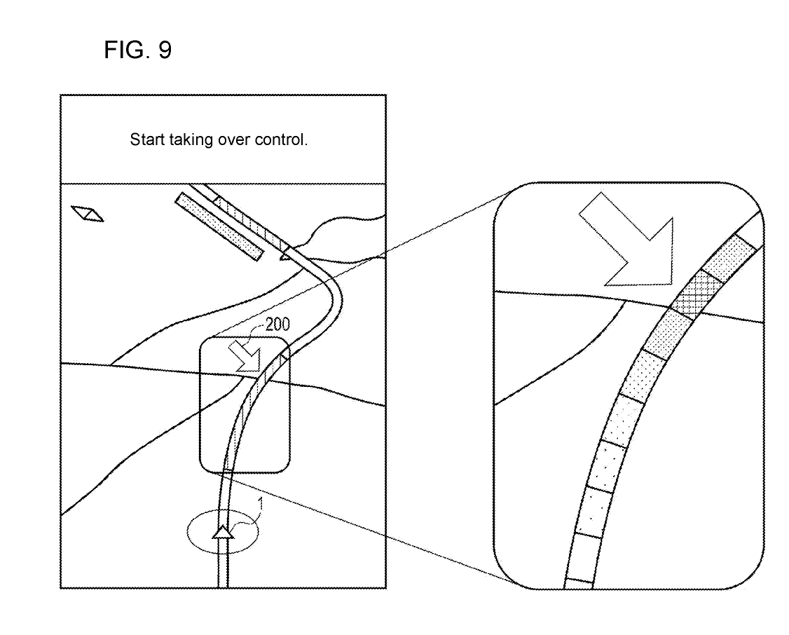

As shown in FIG. 7, a voice message stating “500 meters to the recommended switch point.” may be output by calculating the distance from the current position of the vehicle 1 to the recommended mode switching position. Further, as shown in FIG. 8, a voice message stating “40 seconds until the recommended switch point.” may be output by calculating the time length to reach the recommended mode switching position, which is calculated by dividing the distance from the current position of the vehicle 1 to the recommended mode switching position by the current speed of the vehicle 1. A higher volume of such voice notification may awaken the driver, which can be an advantageous effect unachievable by visual notification.

In a switching section, recommendation degrees may range across areas within the switching section. Thus, as shown in FIG. 9, a color map image including the distribution of recommendation degrees associated with display colors may be generated and displayed on the display 9.

FIG. 9 is a diagram describing a strip icon indicating a switching section in detail. As shown in FIG. 9, numerical indexes each indicating the degree of recommendation about the mode switching may be mapped with colors that are deeper (hatched differently) as the recommendation degree is higher. This structure provides the driver with more information, thus further assisting the driver by providing information to the driver.

The mode switch assisting apparatus 6 may be provided as a dedicated built-in hardware device, or may be incorporated in a known in-vehicle device (e.g., the navigation system 50).

Further, the mode switch assisting apparatus 6 may be combined with a technique for numerically evaluating the state of the driver from video data for the driver captured by the driver camera 7. Such combination can provide a safer system, which may also determine whether a voice announcement is to be output.

The apparatus according to each of one or more embodiments may also be implemented by a computer and a program, which may be stored in a recording medium, or provided through a network. The controller according to one or more embodiments and its device components may be implemented by hardware or a combination of hardware resources and software. The software to be combined is a program preliminarily installed in a computer through a network or from a computer readable recording medium, and executed by a processor included in the computer to perform the function of each unit.

A processor used in association with a computer or the term hardware processor herein includes a circuit such as a CPU, a graphics processing unit (GPU), an application specific integrated circuit (ASIC), a simple programmable logic device (SPLD), a complex programmable logic device (CPLD), and an FPGA.

The processor reads a program stored in the memory and executes the program to implement the specific functions based on the program. The program may not be stored in the memory but may be directly incorporated in the circuit of the processor. In that case, the processor reads the program incorporated in the circuit to perform the functions.

Other details including the type of vehicle, the functions of the automatic driving controller, and the functions, procedure, and control of the mode switch assisting apparatus may be modified variously without departing from the spirit and scope of the present invention.

The present invention is not limited to embodiments above, but the components may be modified without departing from the spirit and scope of the invention. The components described in one or more embodiments may be combined as appropriate to provide various aspects. For example, some of the components described in one or more embodiments may be eliminated. Further, components in different embodiments may be combined as appropriate.

One or more embodiments may be partially or entirely expressed in, but not limited to, the following forms shown in the appendixes below.

### Appendix 1

An assisting apparatus for assisting in switching a drive mode of a vehicle between a manual drive mode and an automatic drive mode, the apparatus comprising a hardware processor and a memory, the hardware processor being configured to

obtain surrounding data representing a surrounding situation of the vehicle;

calculate a recommended mode switching position at which the mode switching is recommended based on the obtained surrounding data; and

store positional information indicating the calculated recommended mode switching position into the memory.

### Appendix 2

An assisting method for assisting in switching a drive mode of a vehicle between a manual drive mode and an automatic drive mode, the method comprising:

obtaining, with at least one hardware processor, surrounding data representing a surrounding situation of the vehicle; and

calculating, with the at least one hardware processor, a recommended mode switching position at which the mode switching is recommended based on the obtained surrounding data.

### REFERENCE SIGNS LIST

1 vehicle
2 power unit
3 steering unit
4 steering wheel
5 automatic driving controller
6 mode switch assisting apparatus
7 driver camera
9 display
10 speaker
12 accelerator pedal sensor
13 brake pedal sensor
14 storage
14a digital map data
15 GPS receiver
16 communication unit
50 navigation system
control unit
61a obtaining unit
61b calculation unit
61c notification unit
61d section defining unit
63 storage
63a map data
63b traffic data
63c road geometry data
63d recommended mode switching position data
63e display image data
100 mode switch assisting system
200 symbol icon

1. An assisting apparatus for assisting in switching a drive mode of a vehicle between a manual drive mode and an automatic drive mode, the apparatus comprising a processor configured with a program to perform operations comprising:
operation as an obtaining unit configured to obtain surrounding data representing a surrounding situation of the vehicle;
operation as a calculation unit configured to calculate a recommended mode switching position at which the mode switching is recommended based on the obtained surrounding data;
operation as a section defining unit configured to define, in response to an intention of an operator to switch the drive mode, a switching section for the mode switching including the recommended mode switching position on a road traveled by the vehicle; and
operation as a notification unit configured to notify the recommended mode switching position and the defined switching section to a driver of the vehicle.

2. The assisting apparatus according to claim 1, wherein the processor is configured with the program to perform operations such that:
operation as the obtaining unit is further configured to obtain map data about surroundings of the vehicle from a database storing digital map data; and
operation as the calculation unit is further configured to calculate the recommended mode switching position based on the obtained map data.

3. The assisting apparatus according to claim 2, wherein
the processor is configured with the program to perform operations such that operation as the calculation unit is further configured to calculate a curvature of a road in a traveling direction of the vehicle based on the map data, and calculates the recommended mode switching position using the curvature as a criterion.

4. The assisting apparatus according to claim 1, wherein
the processor is configured with the program to perform operations further comprising operation as a reception unit configured to receive public traffic information, and
the processor is configured with the program to perform operations such that operation as the calculation unit is further configured to calculate the recommended mode switching position based on the received public traffic information.

5. The assisting apparatus according to claim 4, wherein
the processor is configured with the program to perform operations such that operation as the calculation unit is further configured to calculate the recommended mode switching position using a congestion situation in a traveling direction of the vehicle obtained from the public traffic information as a criterion.

6. The assisting apparatus according to claim 1, wherein
the processor is configured with the program to perform operations such that operation as the notification unit is further configured to display the recommended mode switching position superimposed on a map image of surroundings of the vehicle on a display.

7. The assisting apparatus according to claim 1, wherein
the processor is configured with the program to perform operations such that operation as the notification unit is further configured to notify, with a voice, a time length to reach the recommended mode switching position to the driver of the vehicle.

8. The assisting apparatus according to claim 1, wherein the processor is configured with the program to perform operations such that:
operation as the calculation unit is further configured to calculate a distribution of numerical indexes each indicating a degree of recommendation about the mode switching in the switching section; and
operation as the notification unit is further configured to associate the indexes with display colors on a map image of surroundings of the vehicle to display the indexes in a color map.

9. An assisting method for assisting, with a computer, in switching a drive mode of a vehicle between a manual drive mode and an automatic drive mode, the method comprising:
obtaining, with the computer, surrounding data representing a surrounding situation of the vehicle;
calculating, with the computer, a recommended mode switching position at which the mode switching is recommended based on the obtained surrounding data;
defining, with the computer, in response to an intention of an operator to switch the drive mode, a switching section for the mode switching including the recommended mode switching position on a road traveled by the vehicle; and
notifying, with the computer, the recommended mode switching position and the defined switching section to a driver of the vehicle.

10. A non-transitory computer-readable storage medium storing a program, which when read and executed, causes a computer to function as the assisting apparatus according to claim 1.

11. A non-transitory computer-readable storage medium storing a program, which when read and executed, causes a computer to function as the assisting apparatus according to claim 2.

12. A non-transitory computer-readable storage medium storing a program, which when read and executed, causes a computer to function as the assisting apparatus according to claim 3.

13. A non-transitory computer-readable storage medium storing a program, which when read and executed, causes a computer to function as the assisting apparatus according to claim 4.

14. A non-transitory computer-readable storage medium storing a program, which when read and executed, causes a computer to function as the assisting apparatus according to claim 5.

15. A non-transitory computer-readable storage medium storing a program, which when read and executed, causes a computer to function as the assisting apparatus according to claim 6.

16. A non-transitory computer-readable storage medium storing a program, which when read and executed, causes a computer to function as the assisting apparatus according to claim 7.

17. A non-transitory computer-readable storage medium storing a program, which when read and executed, causes a computer to function as the assisting apparatus according to claim 8.
